(19) United States
(12) Patent Application Publication
(10) Pub. No.: US 2024/0003102 A1
(43) Pub. Date: Jan. 4, 2024

(54) PAVER FEEDER ASSEMBLIES, SYSTEMS, AND METHODS FOR PHOTOVOLTAIC MODULE MOUNTING SYSTEMS AND AUTOMATED SOLAR PLANT INSTALLATION

(71) Applicants: Nicholas Paul Carter, San Carlos, CA (US); Mario Bogdan, Belmont, CA (US)

(72) Inventors: Nicholas Paul Carter, San Carlos, CA (US); Mario Bogdan, Belmont, CA (US)

(21) Appl. No.: 18/215,218

(22) Filed: Jun. 28, 2023

Related U.S. Application Data
(60) Provisional application No. 63/356,658, filed on Jun. 29, 2022.

(51) Int. Cl. E01C 19/00; B60P 1/44; B60P 3/00

(52) U.S. Cl. CPC E01C 19/00; B60P 1/44; B60P 3/00; E01C 2301/02

(57) ABSTRACT

Paver feeder assemblies, systems, and methods for use in mounting photovoltaic modules are provided which comprise a support structure and an elevator. The support structure is configured to support a plurality of pavers arranged in a stack. The elevator is configured to move the single paver from the support structure and to release the single paver into a mounting tub. The elevator may be a crane gantry configured to move in three axes. A restraining mechanism may be provided, which is configured to separate a single paver from the stack. The elevator may be a shelf assembly comprising one or more side restraints and one or more grippers configured to grasp a single paver and move from a start position adjacent to the support structure to lower the single paver to an end position directly above a floor of a mounting tub. The paver feeder assembly may be mounted on a mobile unit that is loaded with pavers at a staging area and moved to a dispensing area where mounting tubs are located.

### CROSS-REFERENCE TO RELATED APPLICATION

This application is a non-provisional of and claims priority to U.S. Patent Application Ser. No. 63/356,658, filed Jun. 29, 2022, which is hereby incorporated by reference in its entirety.

### FIELD

The present disclosure relates to the field of solar power generation and to the large-scale installation of mounting systems for solar photovoltaic (PV) modules.

### BACKGROUND

Photovoltaic (PV) systems consisting of numerous PV modules are being installed in growing numbers. Also growing rapidly is the number of modules used in such installations, up to hundreds of thousands or millions of modules in some cases.

One method for mounting PV modules uses ballasted “tubs” that are commonly made of plastic and are weighted down by concrete ballast blocks placed inside. The PV modules are then clamped to the top of the mounting tubs. Sites may use as many tubs as PV modules, and there may be multiple concrete ballast pavers deployed in each tub.

Therefore, there exists a need for improved assemblies, systems, and methods for installing mounting systems for PV modules at large scale. There is a need for a system and method to automate the deployment of the numerous concrete blocks, instead of the current manual placement process. There also is a need for assemblies, systems, and methods that make PV module installation more efficient.

### SUMMARY

The present disclosure, in its many embodiments, alleviates to a great extent the disadvantages of known mounting systems for photovoltaic module installation. Embodiments of the disclosure automate the deployment and dispensing of concrete pavers, thus facilitating the module installation process, which is especially significant for larger scale PV power plants.

Disclosed embodiments include a paver feeder assembly that holds a stack of concrete pavers and may be mounted to an autonomous cart or mobile unit. The paver feeder assembly deploys individual pavers or multiple pavers into each tub by moving around the site on the autonomous cart. When the feeder assembly is empty, the autonomous cart returns to a staging area to be refilled. The automated feeder assembly mounted on the autonomous cart/mobile unit advantageously deploys concrete pavers into mounting tubs in prescribed numbers, travelling along the rows of deployed tubs.

Embodiments of the disclosure automate the installation of concrete ballast blocks into the mounting “tubs” for supporting PV modules, thus facilitating the module installation process, which is especially significant for these larger scale PV power plants. Embodiments of the disclosure may be used in conjunction with systems and methods described and claimed in co-pending U.S. patent application Ser. No. 17/316,968, filed May 1, 2021, U.S. patent application Ser. No. 17/866,769, filed Jul. 18, 2022, and U.S. Pat. No. 8,635,773, issued Jan. 28, 2014, each of which is hereby incorporated by reference in its entirety.

Exemplary embodiments of a paver feeder assembly comprise a support structure and an elevator. The support structure is configured to support a plurality of pavers arranged in a stack. The elevator is configured to move the single paver from the support structure and to release the single paver into a mounting tub. In exemplary embodiments, the support structure is a flat bed, and the elevator is a crane gantry configured to move in three axes. The flat bed and the moveable crane gantry may be mounted on a mobile unit. The mobile unit has a left side, a right side, an upper surface, a front end, and a back end, and the paver feeder assembly is mounted on the mobile unit.

In exemplary embodiments, a restraining mechanism is provided, which is configured to separate a single paver from the stack while restraining the rest of the pavers in the stack. In exemplary embodiments, the support structure is a hopper, and the elevator is a shelf assembly comprising a shelf, one or more side restraints, and one or more grippers configured to grasp a single paver of the plurality of pavers. The shelf assembly may be configured to move from a start position adjacent to the hopper to lower the single paver to an end position directly above a floor of a mounting tub. In exemplary embodiments, the shelf assembly also is configured to move from the end position back up to the start position after releasing the single paver. The restraining mechanism may include stub components configured to restrain the plurality of pavers. In exemplary embodiments, the stub components are configured to withdraw to separate the single paver from the stack while continuing to restrain the plurality of pavers.

An exemplary paver feeder system comprises a mobile unit and a paver feeder assembly mounted on the mobile unit. The paver feeder assembly comprises a support structure, and an elevator configured to move the single paver from the support structure and to release the single paver into a mounting tub. In exemplary embodiments, the support structure is a flat bed configured to support a plurality of pavers arranged in a stack and the elevator is a moveable crane gantry comprising a gripper attachment with grabber end attachments. The moveable crane gantry is configured to move the single paver so the single paver is released into a mounting tub. In exemplary embodiments, the moveable crane gantry is configured to move in three axes.

Exemplary embodiments have a restraining mechanism configured to separate a single paver from the stack while restraining the rest of the pavers in the stack. The restraining mechanism may comprise stub components configured to restrain the plurality of pavers. The stub components are configured to withdraw to separate the single paver from the stack while continuing to restrain the plurality of pavers. In exemplary embodiments, the mobile unit is programmed with data about spacing between a plurality of mounting tubs such that the paver feeder system moves from one mounting tub to the next. In exemplary embodiments, the mobile unit dispenses a pre-determined number of pavers into the mounting tubs.

Exemplary methods of dispensing pavers in mounting tubs are provided, comprising the steps of loading a stack of pavers onto a support structure, separating a first paver, lowering the first paver into a mounting tub, separating a second paver, and lowering the second paver into the mounting tub on top of the first paver. The support structure may be mounted on a mobile unit.

In exemplary embodiments, the loading step is performed at a staging area. Disclosed methods may further comprise moving the mobile unit from the staging area to a dispensing area comprising a plurality of mounting tubs. The method steps may include moving the mobile unit from a first mounting tub to a second mounting tub when the first mounting tub contains the pre-determined number of pavers. When the hopper is empty of pavers the mobile unit moves from the dispensing area to the staging area to load more pavers.

Accordingly, it is seen that assemblies, systems, and methods of deploying pavers for installing photovoltaic modules are provided. These and other features of the present disclosure will be appreciated from review of the following detailed description, along with the accompanying figures in which like reference numbers refer to like parts throughout.

### BRIEF DESCRIPTION OF THE DRAWINGS

The foregoing and other objects of the disclosure will be apparent upon consideration of the following detailed description, taken in conjunction with the accompanying drawings, in which:

FIG. 1 is a perspective view of an exemplary embodiment of a paver feeder system in accordance with the present disclosure;

FIG. 2 is a perspective view of an exemplary embodiment of a paver feeder system in accordance with the present disclosure;

FIG. 3 is a perspective view of an exemplary embodiment of a paver feeder system in accordance with the present disclosure;

FIG. 4A is a perspective view of an exemplary embodiment of a paver feeder system in accordance with the present disclosure;

FIG. 4B is a perspective view of an exemplary embodiment of a paver feeder system in accordance with the present disclosure;

FIG. 5A is a side perspective view of an exemplary embodiment of a paver feeder system in accordance with the present disclosure;

FIG. 5B is a rear view of an exemplary embodiment of a paver feeder system in accordance with the present disclosure;

FIG. 5C is a rear view of an exemplary embodiment of a paver feeder system in accordance with the present disclosure;

FIG. 6A is a rear view of an exemplary embodiment of a paver feeder system in accordance with the present disclosure;

FIG. 6B is a perspective view of an exemplary embodiment of a paver feeder system in accordance with the present disclosure;

FIG. 7A is a perspective view of an exemplary embodiment of a paver feeder assembly showing an exemplary hopper and elevator assembly in accordance with the present disclosure;

FIG. 7B is a front perspective view of an exemplary embodiment of a paver feeder assembly showing an exemplary hopper and elevator assembly in accordance with the present disclosure;

FIG. 8 is a perspective view of an exemplary embodiment of a moveable crane gantry in accordance with the present disclosure;

FIG. 9 is a perspective view of an exemplary embodiment of a paver feeder system with a moveable crane gantry in accordance with the present disclosure;

FIG. 10 is a detail view of part of an exemplary embodiment of a moveable crane gantry in accordance with the present disclosure;

FIG. 11A is a perspective view of an exemplary embodiment of a moveable crane gantry gripper mechanism in accordance with the present disclosure;

FIG. 11B is a perspective view of an exemplary embodiment of a moveable crane gantry gripper mechanism in accordance with the present disclosure;

FIG. 11C is a perspective view of an exemplary embodiment of a moveable crane gantry gripper mechanism in accordance with the present disclosure;

FIG. 11D is a perspective view of an exemplary embodiment of a moveable crane gantry in accordance with the present disclosure;

FIG. 12 is a perspective view of spaced apart mounting tubs in accordance with the present disclosure;

FIG. 13 is a perspective view of an exemplary embodiment of a paver feeder system in operation in accordance with the present disclosure;

FIG. 14 is a process flow diagram of an exemplary control system for a paver feeder system in accordance with the present disclosure; and

FIG. 15 is a block diagram showing an exemplary embodiment of the internal structure of a computer in which various embodiments of the disclosure may be implemented.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure. As used herein, the “present disclosure” refers to any one of the embodiments described herein, and any equivalents.

Furthermore, reference to various aspects of the disclosure throughout this document does not mean that all claimed embodiments or methods must include the referenced aspects. Reference to shape, orientation, and other parameters should be considered as representative and illustrative of the capabilities of exemplary embodiments, and embodiments can operate with a wide variety of such parameters. It should be noted that the figures do not show every piece of equipment.

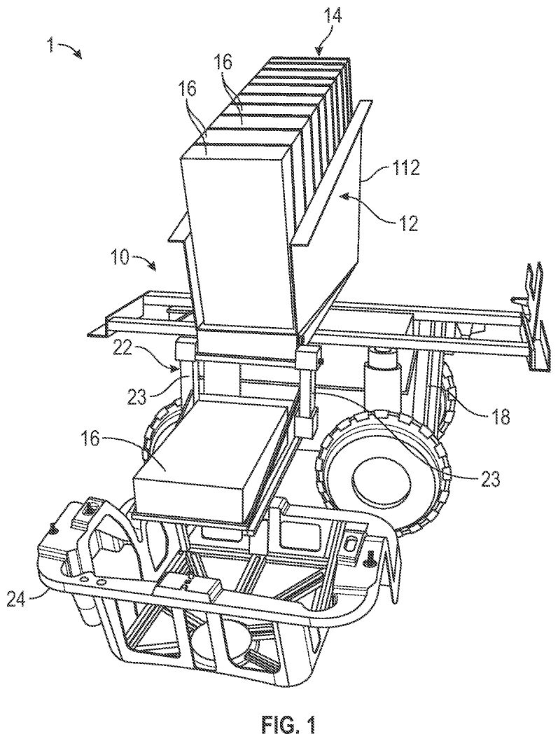

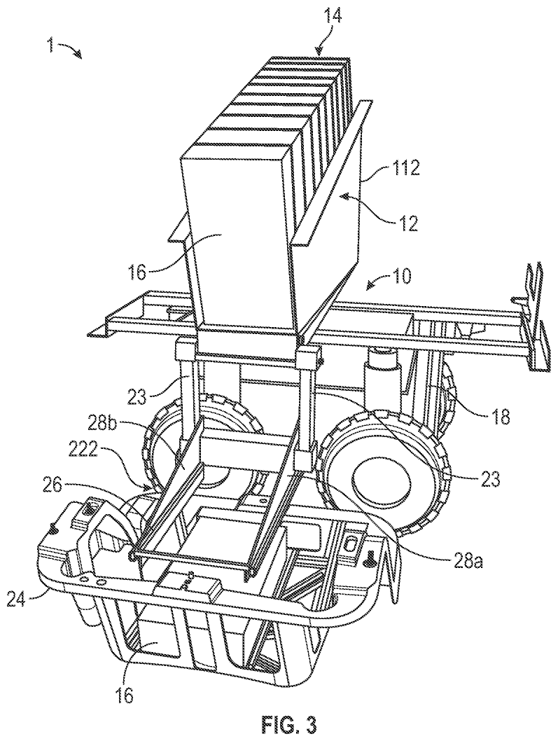

Referring to FIGS. 1-7B, an exemplary paver feeder system 1 and assembly 10 for dispensing concrete pavers will be described. An exemplary feed mechanism comprises one or more of the following parts: a support structure for holding a stack of pavers, a restraining mechanism that separates a single concrete paver from the stack, ready for dispensing, a shelf mechanism that retains a single concrete paver, and an elevator mechanism that lowers the shelf and therefore a single paver onto the bottom of the plastic tub.

In exemplary embodiments, a paver feeder system 1 includes an automated paver feeder assembly 10 that is comprised of a support structure 12 or other suitable containing framework that supports a stack 14 of concrete pavers 16. The support structure 12 may be mounted on an autonomous cart or mobile unit 18. In exemplary embodiments, the support structure 12 is a hopper 112 loaded with a stack 14 of concrete ballast pavers 16. As described in more detail herein, a restraining mechanism 20 restrains the stack 14 of pavers 16 and functions to separate individual pavers 16 from the stack 14 one paver at a time. In exemplary embodiments, stack 14 is constrained by stub components 36 positioned within the paver feeder assembly 10. An elevator 22 with linear actuators 23 moves each individual paver 16 so each paver is released, sequentially, into a mounting tub 24. Typically, the paver feeder assembly 10 is mounted on the mobile unit 18.

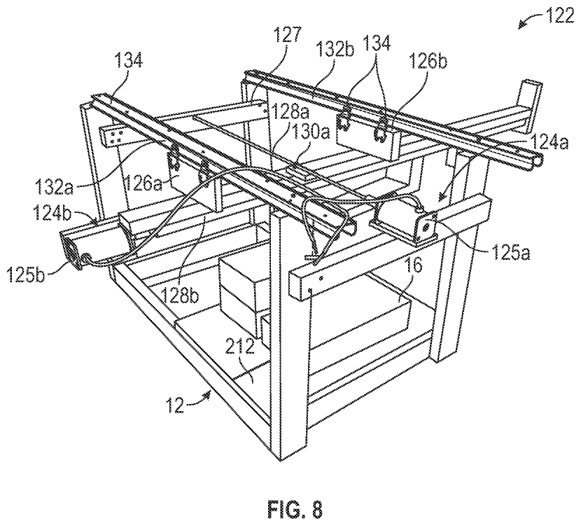

In exemplary embodiments, illustrated in FIGS. 8-11D, support structure 12 is a flat bed 212, and elevator 22 is a moveable crane gantry 122. Capable of moving in three axes, moveable crane gantry 122 may be mounted on mobile unit 18 that uses a gantry gripper attachment 37 to grasp individual concrete pavers 16 from one or more stacks 14 of pavers 16 on the mobile unit 18. The paver feeder system 1 then uses the moveable crane gantry 122 to deliver each paver 16 in turn into the plastic mounting tub 24, which typically sits on the ground or on a rooftop membrane and is used to mount photovoltaic modules.

An exemplary moveable crane gantry 122 is comprised of two drive mechanisms 124a, 124b, best seen in FIG. 8, that move a shuttle 126a in the x and y axes to align the shuttle with stacks 14 of concrete pavers 16 on the top of the mobile unit 18 and to position the shuttle 126a over mounting tub 24. The shuttle 126a is then used to lift, move, and place a concrete paver 16 into the plastic mounting tub 24 via a third mechanism.

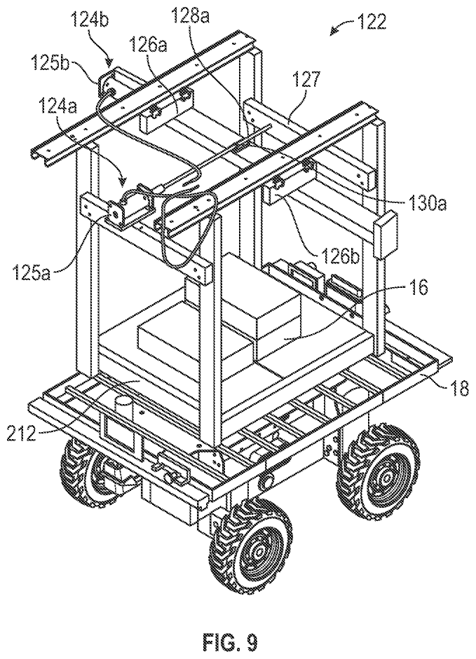

The first mechanism 124a features a drive motor 125a that is fixed to a frame 127 which is in turn mounted to a mobile unit 18. As best seen in FIG. 9, this motor 124a drives a threaded rod 128a, which rotates through a mounted nut 130a attached to a second arm, with the end of the threaded rod mounted in a bushing or bearing at another part of frame 127. As the threaded rod 128a rotates clockwise or anti-clockwise, the second mechanism 124b is moved back-and-forth respectively in the x axis.

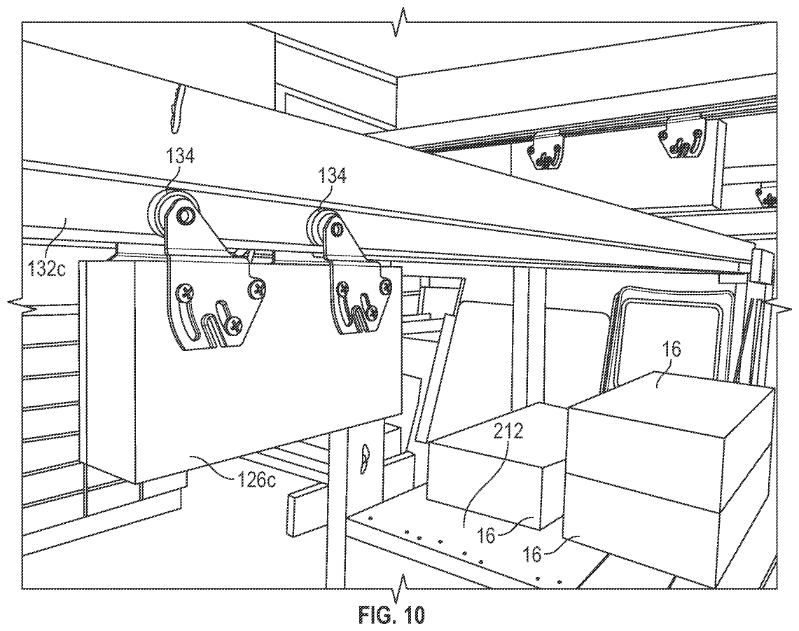

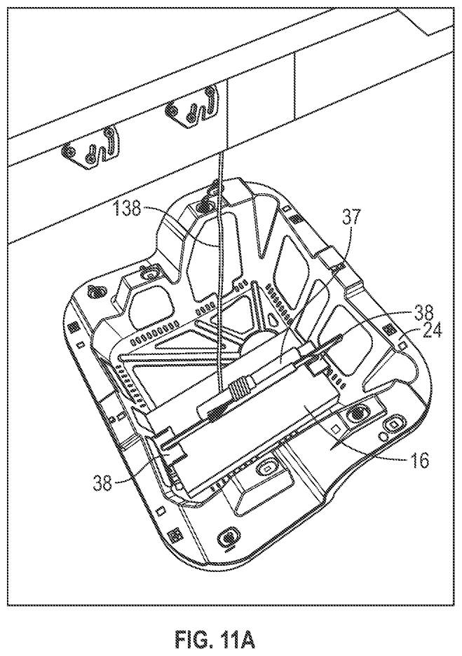

The second mechanism 124b also comprises a drive motor 125b, threaded rod 128b and nut 130b, this time attached to a shuttle 126b; exemplary embodiments have three shuttles 126a, 126b located at opposite sides of the frame 127, and 126c, which runs back and forth on the crane arm (best seen in FIG. 10). The second mechanism 124b is mounted via wheels 134 onto tracks 132a and 132b mounted to the frame 127 attached to the mobile unit 18, so that it can move in the x axis driven by the first mechanism 124. As the drive motor 125b of the second mechanism 124b rotates clockwise or anti-clockwise, it moves the shuttle 126b back-and-forth along the threaded rod 128b.

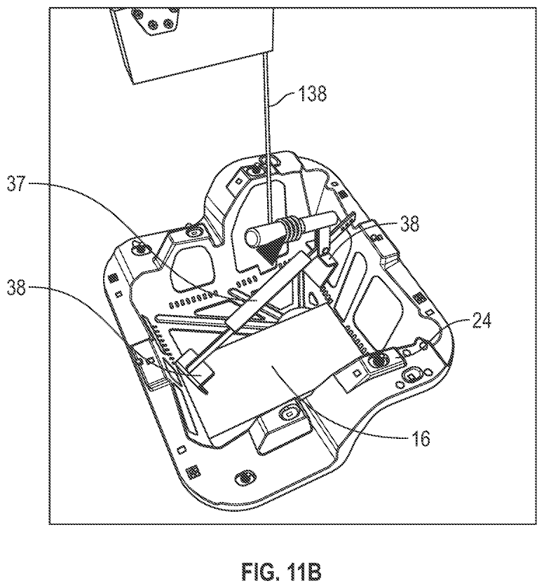

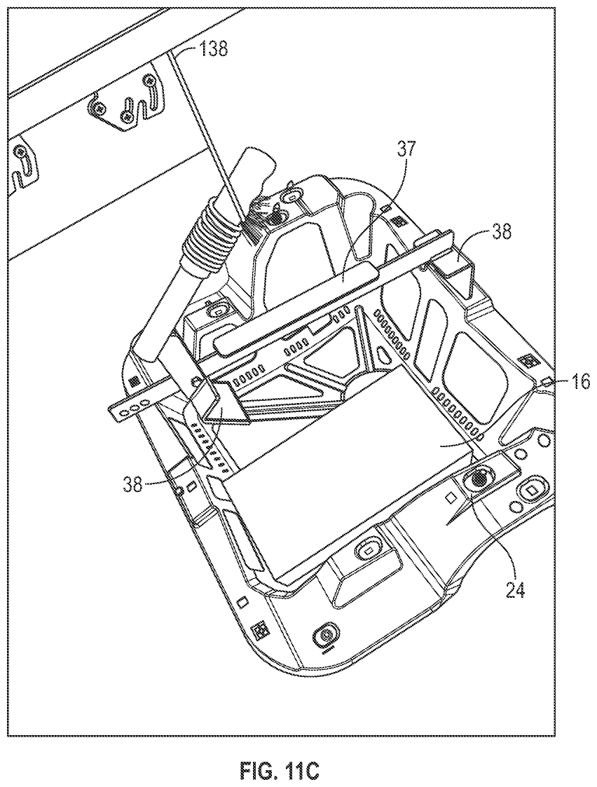

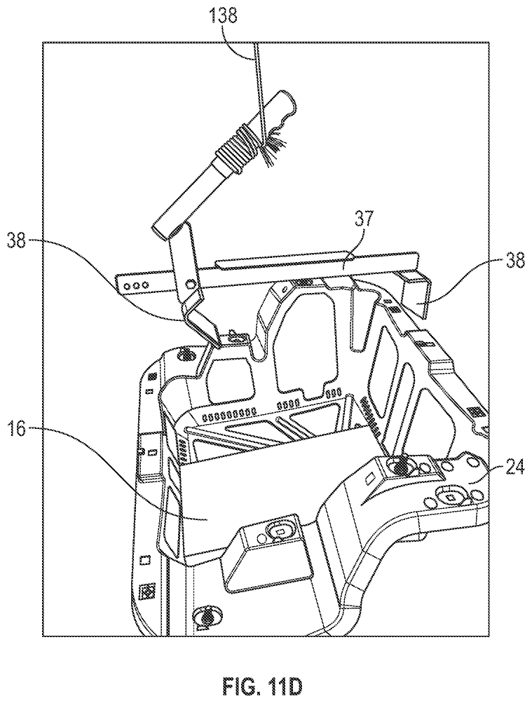

As shown in FIG. 10, shuttle 126c is mounted using wheels 134 on a third track 132c that runs at 90 degrees to the first mechanism 124a and is mounted on the arm moved by the first mechanism. The shuttle 126c is attached to a nut 130b that is moved back and forth by the second mechanism 125 as the drive motor 124b rotates the attached threaded rod 128b. This enables the shuttle 126b to move from above the concrete pavers that are positioned in the bed of the mobile unit 18 out over the mounting tub 24. Referring to FIGS. 11A-11B cable 138 is fed via the shuttle 126b to a gripper attachment 37 that grabs individual concrete pavers 16 using end attachments serving as grabbers 38, so that the pavers 16 can be lifted, moved, and then deposited into the solar mounting tub 24 with the aid of the two mechanisms described above. FIGS. 11C and 11D show the gripper attachment 38 in “release” mode after delivering a concrete paver 16. One or more sensors may be provided to detect the positions of the paver 16 relative to the mounting tub 24 and how many pavers 16 are on the flat bed 212.

Returning to FIGS. 1-3, elevator 22 could include a rotating shelf assembly 222 mounted to the mobile unit 18. Rotating shelf assembly 222 lowers individual concrete pavers 16 from a stack 14 of pavers held within a containing framework mounted on an autonomous cart and then uses an elevator 22 to deliver each paver 16 in turn into the plastic mounting tub 24 which typically sits on the ground or on a rooftop membrane.

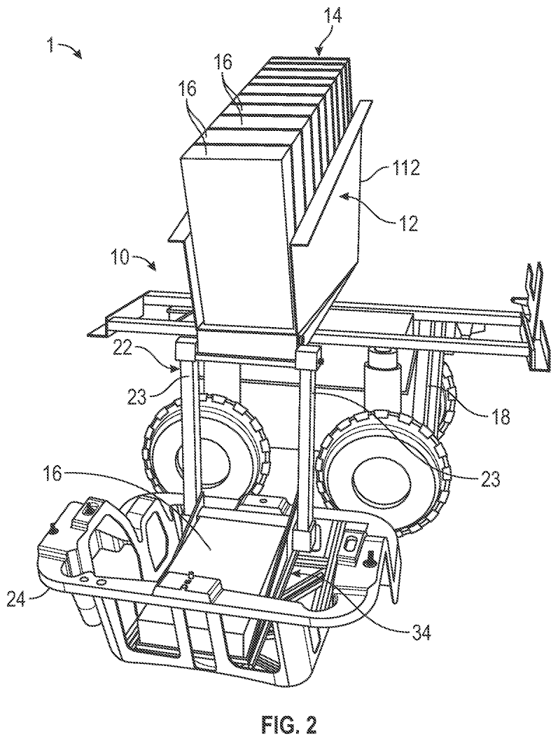

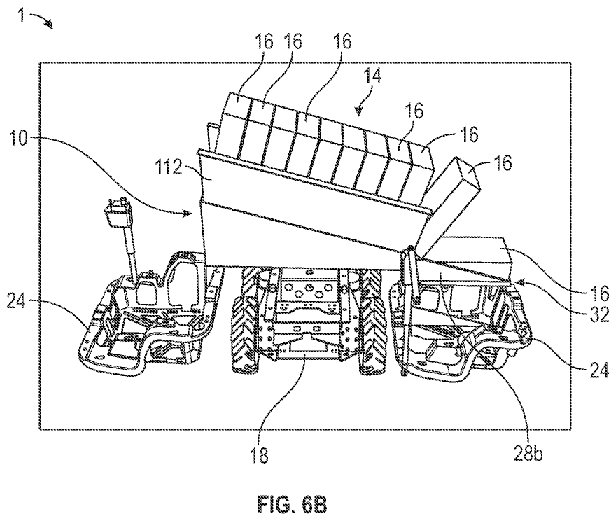

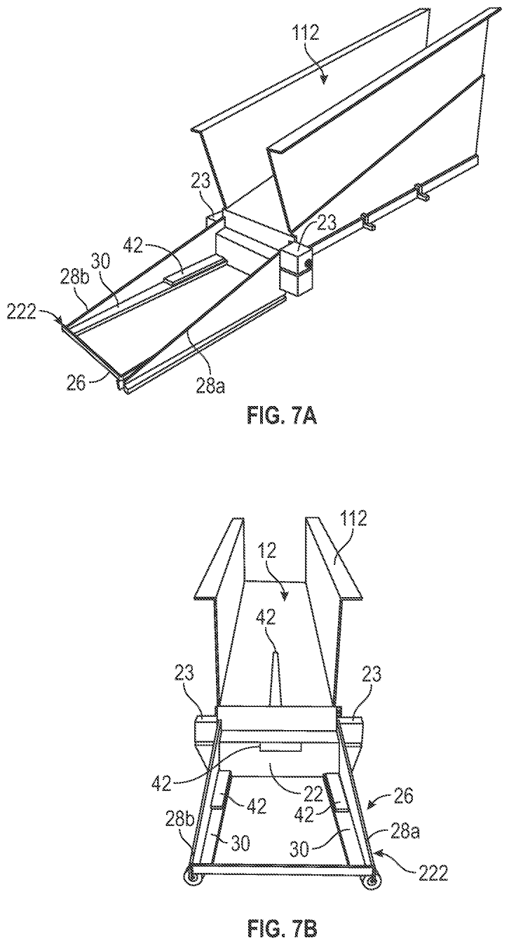

As best seen in FIGS. 7A-7B, an exemplary shelf assembly 222 has a shelf 26 with side restraints 28. In exemplary embodiments, there are two side restraints 28a, 28b positioned at opposite sides of the shelf 26 to constrain an individual concrete paver 16 when the paver is resting on the shelf. One or more grippers 30 are provided as part of the shelf assembly 222 and are formed to hold or constraint and then release an individual paver 16, as described in more detail herein. As best seen in FIG. 6A, shelf assembly 222 has a start position 32 close to the hopper 12. The start position 32 typically is level with or adjacent to the hopper 12 as it is mounted on the mobile unit. As described in more detail herein and shown in FIG. 2, shelf assembly 222 can move from the start position 32 downward to an end position 34 directly above a floor of a mounting tub 24 and then back up to the start position 32. This is to lower a single paver 16 into the mounting tub 24 and then retrieve another paver after releasing the first paver.

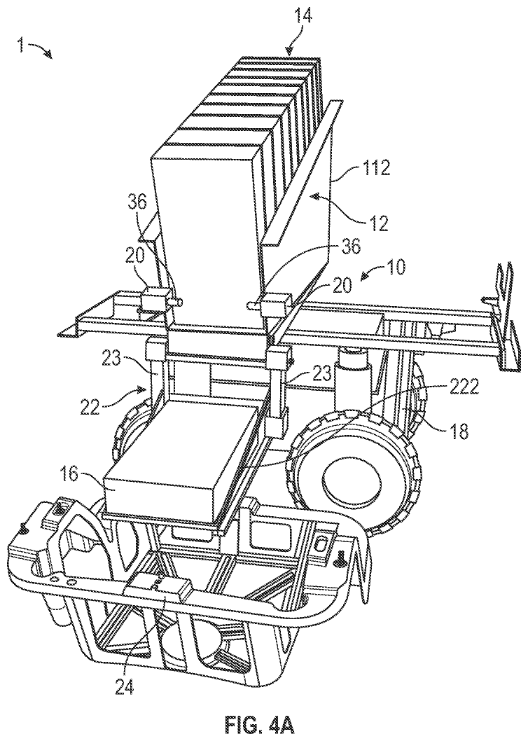

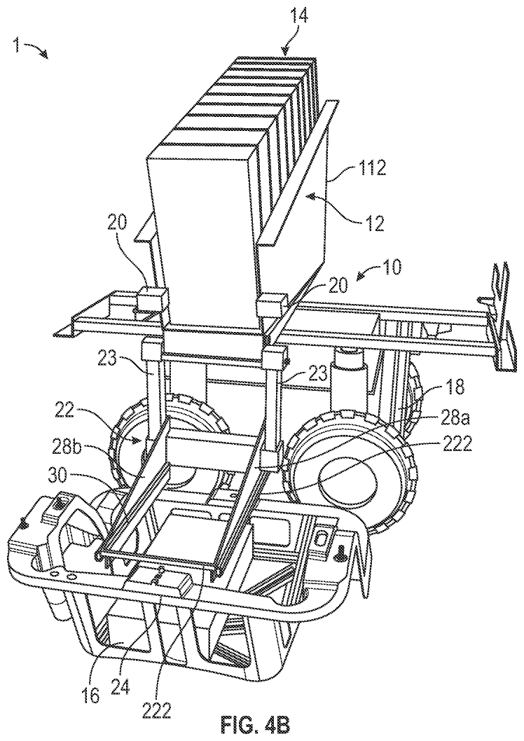

As best seen in FIGS. 4A and 4B, an exemplary restraining mechanism 20 comprises sets of short solenoid-controlled stub components 36 which are positioned within the structure of the paver feeder assembly 10, on either side at the foot of the chute, to restrain the stack 14 of pavers 16. The stub components 36 are withdrawn in sync driven by a control mechanism in order to lower a single concrete paver 16 onto the rotating shelf assembly 222 described above while still supporting the remainder of the stack 14 of pavers 16.

In operation, a stack 14 of concrete ballast pavers 16 is loaded into a hopper 112 comprised of a framework which constrains and supports the pavers 16 in place and aligns them with the paver feeder assembly 10. The hopper 112 and feeder assembly 10 are mounted on a mobile unit 18/autonomous cart that navigates the installation site with minimal human intervention. The hopper 112 structure operates off the side of the mobile unit 12 and may be tilted at an angle to the vertical to move the center of gravity of the stack 14 of concrete ballast pavers 16 lower to the ground and closer to the center of gravity of the mobile unit 18. To lower the bottom paver onto the shelf mechanism either gravity feeds the pavers down the chute, or a conveyor mechanism is used in conjunction with the insertion or retraction of the stub components.

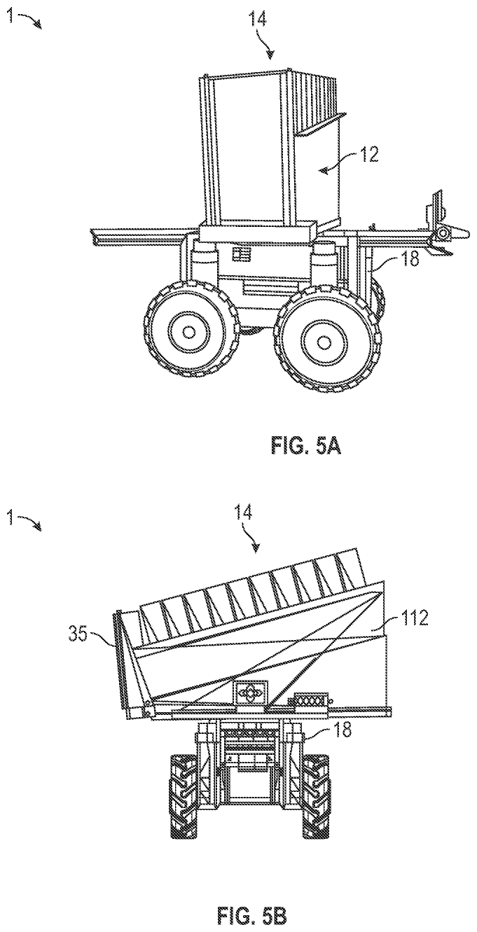

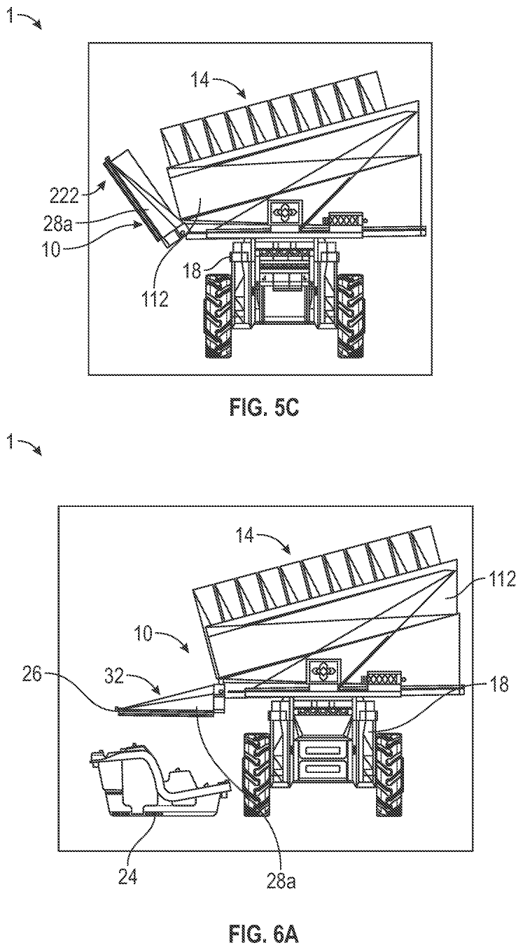

Referring to FIGS. 4A and 4B, the stack 14 of pavers 16 is held in place by restraining mechanism 20. In exemplary embodiments, the stub components 36 are withdrawn in sync, driven by a control system 40 to separate the first paver 16 from the stack 14 and lower it onto the rotating shelf assembly 222, as illustrated in FIGS. 5A-6B. When the separated bottom paver 16 is in place and constrained by the shelf assembly 222, a control system starts the mechanism rotating until the shelf 22 and paver 16 are horizontal. Thus, the shelf assembly 222 rotates the separated individual paver 16 to a horizontal position. The grippers 30 that form the lower sides of the shelf 22 restrain the paver 16 along with side restraints 28a, 28b.

As shown in FIGS. 1-3, the elevator 22 (shelf) then lowers via its elevator mechanism until it is on the floor of the mounting tub 24 until the paver 16 is in position at the bottom of the mounting tub 24. Shelf assembly 222 delivers the paver 16 onto the bottom of the tub 24, which may be on the ground or on a rooftop surface. Once a sensor indicates that this position has been reached, the grippers 30 that form the sides of the shelf assembly 222 release the paver 16, so that the paver 16 is deployed onto the floor of the mounting tub 24.

The shelf assembly 222 can now be lifted back up, returning to its starting, horizontal, position, raised by the elevator mechanism and rotated to its original position ready to receive the next paver. Once the elevator mechanism is raised to its start position, either one or more pavers are delivered to the same tub by repeating the above sequence, or the mobile unit 18 can move forward. More particularly, when the shelf assembly 222 is retracted, either the procedure described above can be repeated to place multiple pavers 16 in the bottom of the tub 24 or, if sufficient pavers have been deployed, the mobile unit moves forward until it is aligned with the next tub.

If more pavers 16 are required to be placed in the mounting tub 24, on top of any previously-placed pavers, then this sequence is repeated, lowering subsequent pavers into place until they sit on the existing paver or pavers. Otherwise, the mobile unit 18 to which the paver feeder assembly 10 is attached can advance forward, as the elevator 22 is now clear of the mounting tub 24. When the mobile unit 18 has moved clear of the previous tub 24, it can move forward until it is aligned with the next tub in the row, or if it has reached the end of a row, it can move on to the next row. Alternatively, if the hopper 112 is empty of pavers 16 the mobile unit 18 will return to the site staging area to be refilled.

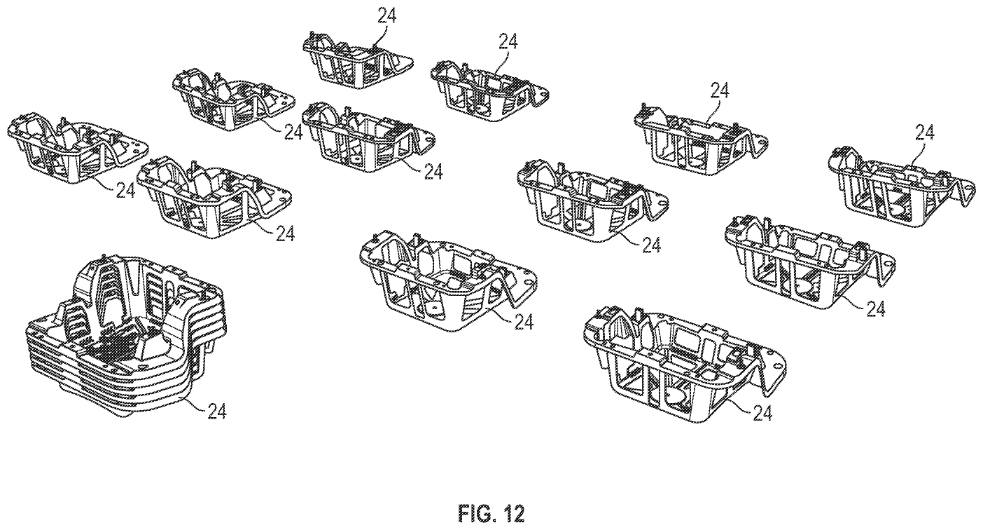

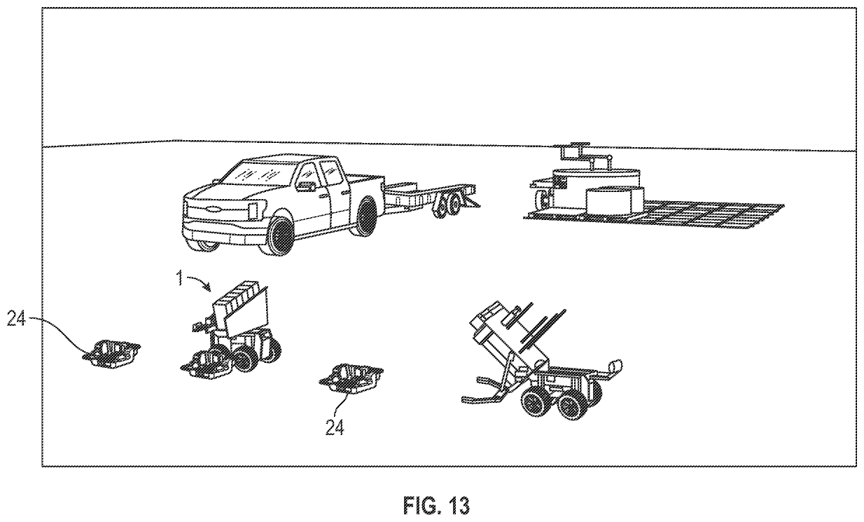

Once the mobile unit control system registers that the mobile unit 18 is alongside the next tub 24 in the row, the above sequence is repeated. The mobile unit 18 dispenses the pavers 16 into mounting tubs 24, located at prescribed intervals within rows that, in turn, have specific inter-row spacing, as shown in FIG. 12. In exemplary embodiments, the mobile unit 18 is programmed with the required spacing between tubs 24 and the inter-row spacing distance, so that it can dispense the correct number of pavers 16 appropriately to construct the solar power plant with minimal human interaction. These sequences and operations can be repeated until a sensor 42 indicates that the hopper 112 is empty of concrete pavers 16 and then the mobile unit 18 returns to the staging area to be re-loaded with more pavers.

It should be noted that moveable crane gantry 122 described above may also be used to dispense pavers 16 into mounting tubs 24, as shown in FIGS. 8-11D. Shuttle 126b is mounted using wheels 134 on track 132b and is mounted on the arm moved by the first mechanism 124a. The shuttle 126b is attached to a nut 130b that is moved back and forth by the second mechanism 124b as the drive motor 124b rotates the attached threaded rod 128b. This enables shuttle 126b to move from above the concrete pavers that are positioned in the bed of the mobile unit 18 out over the mounting tub 24. Cable 138 is fed by shuttle 126b to a gripper attachment 37 that grabs the individual concrete pavers 16 using gantry grabbers 38. Thus, the pavers 16 are lifted from the flat bed 212, moved, and deposited into the solar mounting tub 24 with the aid of the two mechanisms described above. One or more sensors may detect the positions of the paver 16 relative to the mounting tub 24 and how many pavers 16 are on the flat bed 212.

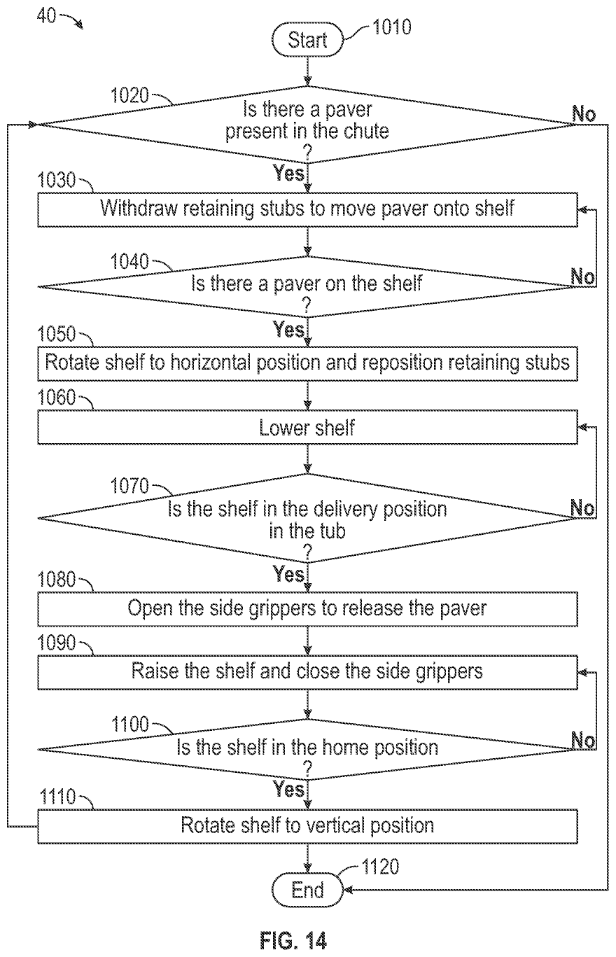

Turning to FIG. 14, an exemplary control system 40 operates as follows. At the start 1010, the control system 40 uses pressure sensors 42 (best seen in FIGS. 7A-7B) to detect 1020 the presence of concrete pavers 16 in the chute or hopper 12. If there is at least one paver 16 present then the stub components 36 are withdrawn 1030 in sync, powered by their servo motors. This frees the lowest paver 16, so that it can lower onto a rotating shelf assembly 22 either by gravity or forced by a separate motor-driven mechanism. The control system 40 then queries 1040 whether the paver 16 has been moved onto the shelf 26.

Once another pressure sensor 42 detects the presence of the paver 16 on the rotating shelf mechanism 222, the rotation mechanism of the shelf is initiated 1050, the constituent drive motors turning it until it is horizontal. The stub components 36 are also re-engaged to extend and thereby restrain the remaining stack 14 of pavers 16. Once that operation is complete, the elevator 22 is initiated and those constituent drive motors (not shown, located within linear actuators 23) lower 1060 the shelf 26 until pressure sensors 42 detect its position in the bottom of the plastic mounting tub 24.

Once the shelf assembly 22 and paver 16 are in delivery position 1070 with respect to the mounting tub 24, the control system 40 initiates the opening 1080 of the side grippers 30 that have held the paver 16 in place within the shelf 26. This releases the paver 16, completing its placement within the mounting tub 24. The shelf assembly 22 can then be returned 1090 to the start position 32 by the control system 40 reversing the drive motors within linear actuators 23 on the elevator 22. Once pressure sensors 42 detect 1100 the presence of the shelf assembly 222 back in its start position 32, the elevator drive motors are shut off and the entire above sequence repeated until the sensors 42 detect no more pavers 16 in the hopper 12. The control system 40 may rotate 1110 the shelf assembly 22 to vertical position 35 after the elevator drive motors are shut off, thus ending 1120 the operation.

The software takes inputs including, but not limited to, number of pavers per tub, length of rows, number of rows, and locations of the mounting tubs, and from those parameters it determines a delivery schedule and the timeline of movements for the automated carts that deliver the pavers to the mounting tubs, as described in this application.

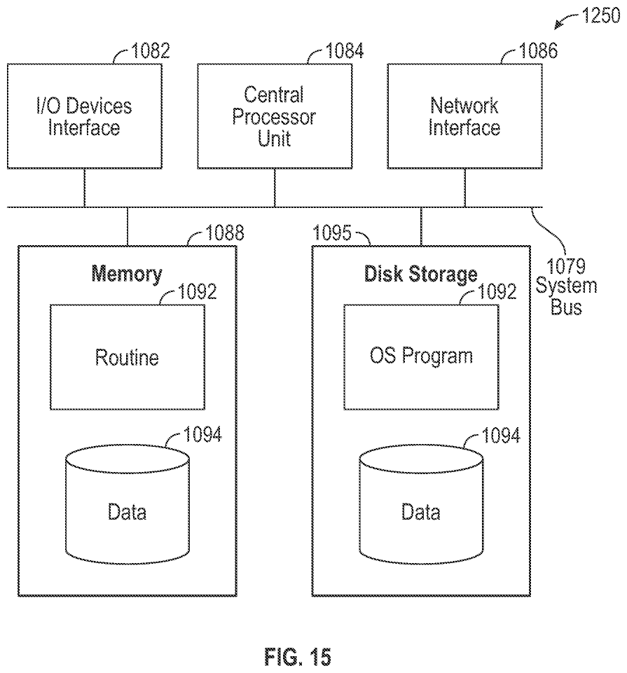

FIG. 15 shows an exemplary internal structure of a computer 1250 by which various embodiments of the present disclosure may be implemented. The computer 1250 contains a system bus 1079, where a bus is a set of hardware lines used for data transfer among the components of a computer or processing system. Bus 1079 is essentially a shared conduit that connects different elements of a computer system (e.g., processor, disk storage, memory, input/output ports, network ports, etc.) that enables the transfer of information between the elements. Attached to system bus 1079 is I/O device interface 1082 for connecting various input and output devices (e.g., sensors, transducers, keyboard, mouse, displays, printers, speakers, etc.) to the computer 1250. Network interface 1086 allows the computer 1250 to connect to various other devices attached to a network (e.g., control system, mobile units, solar installation site, etc.).

Memory 1088 provides volatile storage for computer software instructions 1092 and data 1094 used to implement embodiments of the present disclosure. Disk storage 1095 provides non-volatile storage for computer software instructions 1092 and data 1094 used to implement an embodiment of the present disclosure. Central processor unit 1084 is also attached to system bus 1079 and provides for the execution of computer instructions.

In an exemplary embodiment, the processor routines 1092 (e.g., instructions for the processes/calculations described above) and data 1094 are a computer program product, including a computer readable medium (e.g., a removable storage medium such as one or more DVD-ROMs, CD-ROMs, diskettes, tapes, etc.) that provides at least a portion of the software instructions for the invention system. Computer program product can be installed by any suitable software installation procedure, as is well known in the art. In another embodiment, at least a portion of the software instructions may also be downloaded over a cable, communication and/or wireless connection. Further, the present embodiments may be implemented in a variety of computer architectures. The computer of FIG. 15 is for purposes of illustration and not limitation of the present disclosure.

Thus, it is seen that paver feeder assemblies and systems, mobile units, and PV modules installation methods are provided. It should be understood that any of the foregoing configurations and specialized components may be interchangeably used with any of the systems of the preceding embodiments. Although illustrative embodiments are described hereinabove, it will be evident to one skilled in the art that various changes and modifications may be made therein without departing from disclosed embodiments. It is intended in the appended claims to cover all such changes and modifications that fall within the true spirit and scope of the disclosed embodiment.

What is claimed is:

1. A paver feeder assembly, comprising:
a support structure configured to support a plurality of pavers arranged in a stack; and
an elevator configured to move the single paver from the support structure and to release the single paver into a mounting tub.

2. The paver feeder assembly of claim 1 wherein the support structure is a flat bed, and the elevator is a moveable crane gantry.

3. The paver feeder assembly of claim 2 wherein the moveable crane gantry is configured to move in three axes.

4. The paver feeder assembly of claim 2 wherein the flat bed and the moveable crane gantry are mounted on a mobile unit.

5. The paver feeder assembly of claim 1 further comprising a restraining mechanism configured to separate a single paver from the stack while restraining the stack.

6. The paver feeder assembly of claim 5 wherein the restraining mechanism comprises stub components configured to restrain the plurality of pavers and configured to withdraw to separate the single paver from the stack while continuing to restrain the plurality of pavers.

7. The paver feeder assembly of claim 5 wherein the support structure is a hopper.

8. The paver system of claim 7 wherein the elevator is a shelf assembly comprising a shelf, one or more side restraints, and one or more grippers configured to grasp a single paver of the plurality of pavers.

9. The paver feeder assembly of claim 8 wherein the shelf assembly is configured to move from a start position adjacent to the hopper to an end position directly above a floor of a mounting tub, thereby lowering the single paver, and to move from the end position back up to the start position after releasing the single paver.

10. A paver feeder system comprising:
a mobile unit;
a paver feeder assembly mounted on the mobile unit, the paver feeder assembly comprising:
a support structure configured to support a plurality of pavers arranged in a stack; and
an elevator configured to move the single paver from the support structure and to release the single paver into a mounting tub.

11. The paver feeder system of claim 10 wherein the support structure is a flat bed, and the elevator is a moveable crane gantry comprising a gripper attachment with grabber end attachments.

12. The paver feeder system of claim 10 wherein the support structure is a hopper, and further comprising a restraining mechanism comprising stub components configured to restrain the plurality of pavers and to separate a single paver from the stack while restraining the stack.

13. The paver feeder system of claim 12 wherein the stub components are configured to withdraw to separate the single paver from the stack while continuing to restrain the plurality of pavers.

14. The paver feeder system of claim 10 wherein the paver feeder system dispenses a pre-determined number of pavers into the mounting tubs.

15. A method of dispensing pavers in mounting tubs, comprising:
loading a stack of pavers onto a support structure;
separating a first paver of the stack of pavers;
lowering the first paver into a mounting tub;
separating a second paver of the stack of pavers; and
lowering the second paver into the mounting tub on top of the first paver.

16. The method of claim 15 wherein the support structure is mounted on a mobile unit.

17. The method of claim 16 further wherein the loading step is performed at a staging area.

18. The method of claim 17 further comprising moving the mobile unit from the staging area to a dispensing area comprising a plurality of mounting tubs.

19. The method of claim 18 further comprising moving the mobile unit from a first mounting tub to a second mounting tub when the first mounting tub contains a pre-determined number of pavers.

20. The method of claim 18 further comprising moving the mobile unit from the dispensing area to the staging area when the support structure is empty of pavers.
